(19) United States
(12) Patent Application Publication
(10) Pub. No.: US 2009/0241156 A1
(43) Pub. Date: Sep. 24, 2009

(54) CONTENT REPRODUCING DEVICE

(76) Inventor: Fukashi Nishida, Chiba (JP)

Correspondence Address: BIRCH STEWART KOLASCH & BIRCH, PO BOX 747, FALLS CHURCH, VA, 22040-0747, US

(21) Appl. No.: 12/302,759

(22) PCT Filed: May 28, 2007
(86) PCT No.: PCT/JP2007/060841

§ 371 Date: Nov. 26, 2008

(30) Foreign Application Priority Data
Jun. 1, 2006 (JP) 2006-153426

(51) Int. Cl. H04N 7/173

(52) U.S. Cl. 725/116; 725/134

(57) ABSTRACT

A portable content reproducing device according to the present invention is characterized in that: in the case where the communication status is good, a low bit rate stream file is recorded in a temporary recording device by using a communication band other than a communication band used for high bit rate reproduction; in the case where the communication status is poor or interrupted, a switchover is performed to reproduce a file stored in the temporary storing device from a point at which the communication is interrupted; and, in the case where the communication status is retrieved, high bit rate streaming reproduction is carried out.

### TECHNICAL FIELD

The present invention relates to a content reproducing technique, in particular to a content reproducing device that is a type of content reproducing device, such as a portable terminal, obtaining a content through communication.

### BACKGROUND ART

In recent years, the performance of portable terminals has been improving, and services which deliver a content through communication have become active.

For example, as described in the following patent documents, a system has been proposed which monitors a communication status and changes a reproducing rate of streaming according to the communication status thus monitored.

### Patent Document 1: Japanese Patent Application Publication No. 2005-167675

### Patent Document 2: Japanese Patent Application Publication No. 2004-312569

### DISCLOSURE OF THE INVENTION

### Problems to be Solved by the Invention

However, even in the case of using the above-techniques, when an interruption actually occurs in the communication status, content reproduction cannot be continued. Especially, when the communication status is not good, it is extremely difficult to continue stream reproduction.

An object of the present invention is to enable content reproduction to be continued even when the communication status is not good.

### Means for Solving the Problems

A portable content reproducing device according to the present invention is characterized in that: in the case where the communication status is good, a low bit rate stream file is recorded in a temporary recording device by using a communication band other than a communication band used for high bit rate reproduction; in the case where the communication status is poor or interrupted, a switchover is performed to reproduce a file stored in the temporary storing device from a point at which the communication is interrupted; and, in the case where the communication status is retrieved, high bit rate streaming reproduction is carried out.

In the case of performing AV streaming reproduction in a portable content reproducing device, a low bit rate stream file is, while being reproduced, stored in a temporary recording device when the communication status is good, and, when the communication status is bad or interrupted, the following part of the stream is reproduced with the low bit rate stream file having been recorded in the temporary recording device for reproduction. Furthermore, when the communication status is retrieved, a switchover to the original streaming reproduction at a high bit rate is carried out. By having such a configuration, even when the communication status is not good, reproduction can be performed continuously.

Here, when download of a low bit rate content is completed, it may be configured that a notification of completion is provided. Furthermore, it may be configured that control is performed in which a content group of multiple kinds of bit rates smaller than the bit rate of the stream content is downloaded by using a surplus band and is recorded in the contents recording part. Selection of a content to be used is accordingly enabled, and convenience regarding content reproduction can be improved.

### EFFECTS OF THE INVENTION

According to the present invention, there is an advantage that, in a portable content reproducing device, even in the case where the communication status is worse than a communication status allowing reception of a streaming content, a content can be reproduced continuously.

### BRIEF DESCRIPTION OF THE DRAWINGS

FIG. 1 is a view illustrating a configuration example of a content reproducing system including a portable content reproducing device according to an embodiment of the present invention.

FIG. 2 is a functional block view illustrating a configuration example of the portable content reproducing device according to the present embodiment.

FIG. 3 is a flowchart diagram illustrating a processing flow at a time of initiating streaming.

FIG. 4 is a flowchart diagram illustrating a processing flow during content reproduction.

FIG. 5 is a flowchart diagram illustrating a processing flow at a time of completing content reproduction.

FIG. 6(A) is a timing chart diagram regarding content reproduction according to the first embodiment of the present invention, and FIG. 6(B) is a diagram regarding a technique according to a modification example of the present embodiment and illustrating an example of a content group existing in a server 1.

FIG. 7(A) is a timing chart diagram regarding content reproduction according to a first example of the present embodiment, and FIG. 7(B) is a diagram regarding the first example and illustrating an example of a content group existing in the server 1.

FIG. 8 is a timing chart diagram regarding content reproduction according to a second example of the present embodiment.

FIG. 9 is a timing chart diagram regarding content reproduction according to a third example of the present embodiment. A diagram in FIG. 10 is also described in association therewith.

FIG. 10 is a diagram illustrating a configuration example of a loop file stream according to the third example.

FIG. 11 is a view illustrating a configuration example of a buffer memory according to the third embodiment.

FIG. 12 is a view illustrating a first display example of a content reproducing device according to the present embodiment.

FIG. 13 is a view illustrating a second display example of a content reproducing device according to the present embodiment.

FIG. 14 is a view illustrating a third display example of a content reproducing device according to the present embodiment.

FIG. 15 is a timing chart diagram regarding content reproduction according to a fourth example of the present embodiment.

### BEST MODES FOR CARRYING OUT THE INVENTION

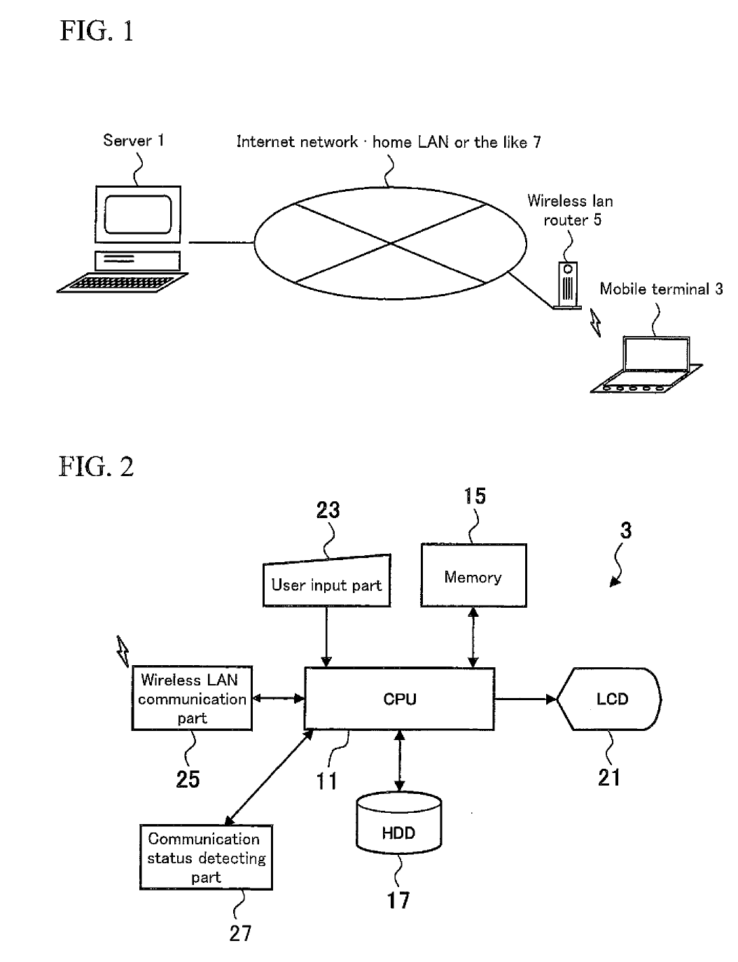

Hereinafter, a portable content reproducing device according to a first embodiment of the present invention will be described by referring to drawings. FIG. 1 is a view illustrating a configuration example of a content reproducing system including a portable content reproducing device according to the present embodiment. As shown in FIG. 1, the portable content reproducing system according to the present embodiment includes: a server 1 that delivers a content; a network 7; a wireless LAN router 5, for example, that performs routing of a content from the network; and a portable content reproducing device (mobile terminal) 3 that obtains a content from the wireless LAN router 5. Note that the content reproducing device is not limited to a portable type.

FIG. 2 is a functional block view illustrating a configuration example of the portable content reproducing device 3 according to the present embodiment. As shown in FIG. 2, the portable content reproducing device 3 according to the present embodiment includes: a CPU 11 that controls the whole device; a memory 15 that functions as a working memory configured to temporarily store a content; an HDD 17 that records a content as well as records a program and the like for content reproduction; an LCD display part 21; a user input part 23; a wireless LAN communication part 25 that performs communication with the wireless LAN router 5; and a communication status detection part 27 that detects a communication status of wireless communication. In some cases, the server 1 may hold contents having the same content at different bit rates.

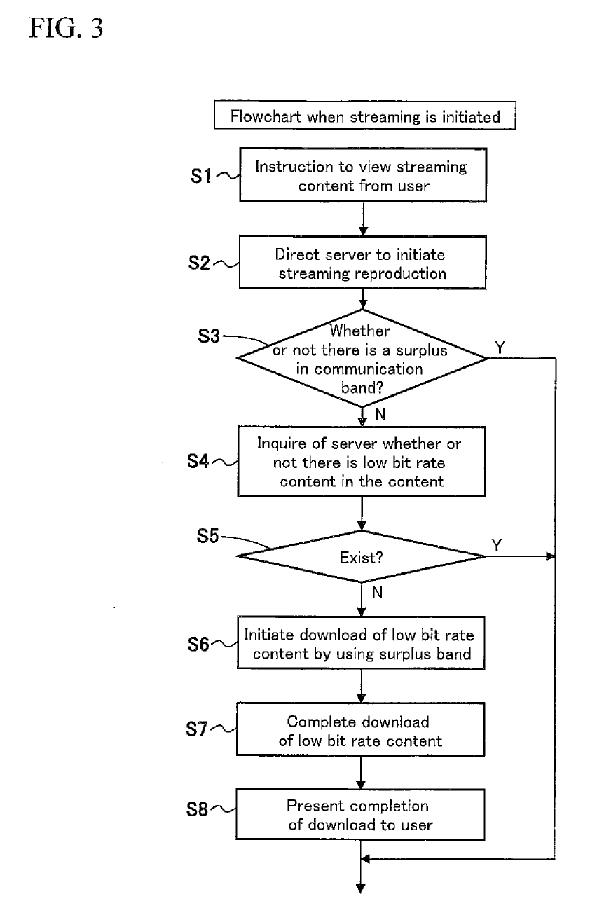

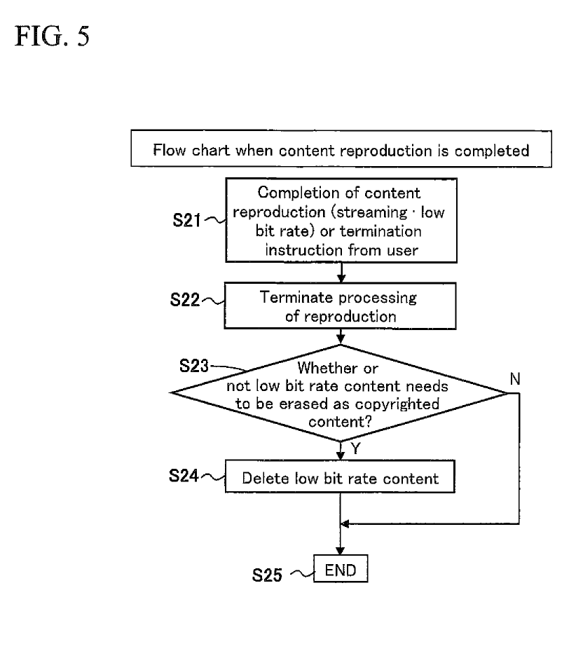

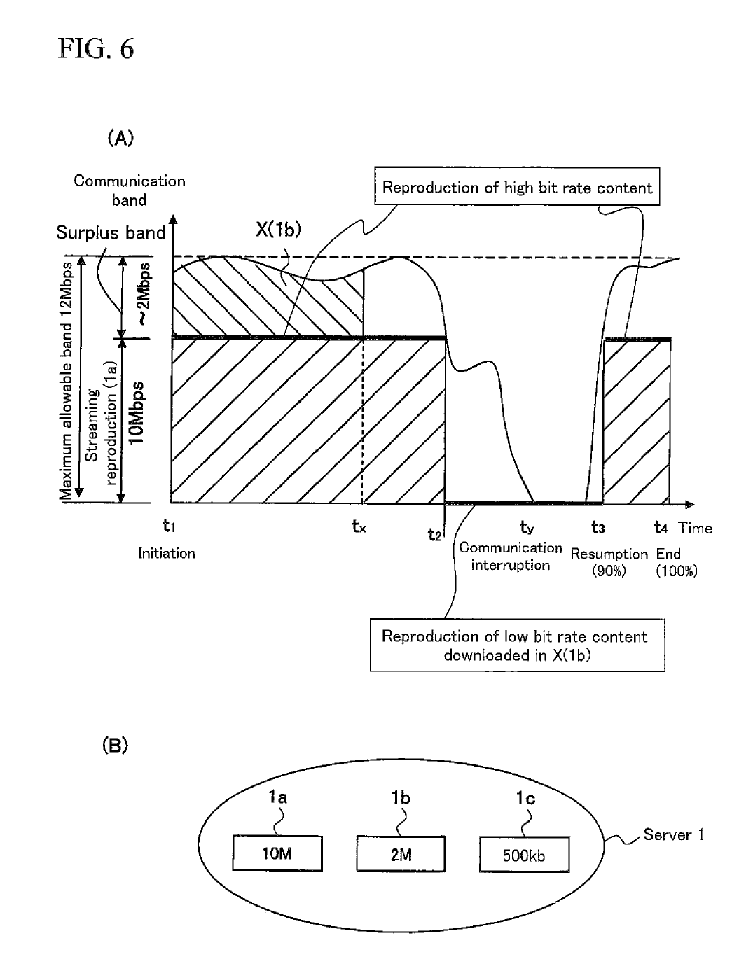

FIG. 3 to FIG. 5 are a flowchart diagram illustrating a processing flow regarding content reproduction. FIG. 6 is a timing chart diagram regarding content reproduction. FIG. 3 is a view illustrating a processing flow at a time of initiating streaming in the portable content reproducing device 3. As shown in FIG. 3, firstly, an instruction to view streaming content is received from a user in a step S1, and then the server 1 is directed to initiate streaming reproduction in a step S2. In a step S3, it is judged whether or not there is a room (surplus band) in a communication bandwidth. If there is no surplus (N), operation skips steps up to a step S8, and then proceeds to a processing in FIG. 5, which will be described later. In the step S3, it is judged whether or not there is a room (surplus band) in the communication band. If there is a surplus (Y), operation proceeds to a step S4, and an inquiry whether or not a low bit rate content is available for this content is sent to the server 1. In a step S5, if no low bit rate content is available (N), operation skips steps up to a step S8. If a low bit rate content (Y) is available, operation proceeds to a step S6, and download of the low bit rate content is initiated by using the surplus band. After the download processing of the low bit rate content is completed in a step S7, a user is notified that the download has been completed in the step S8.

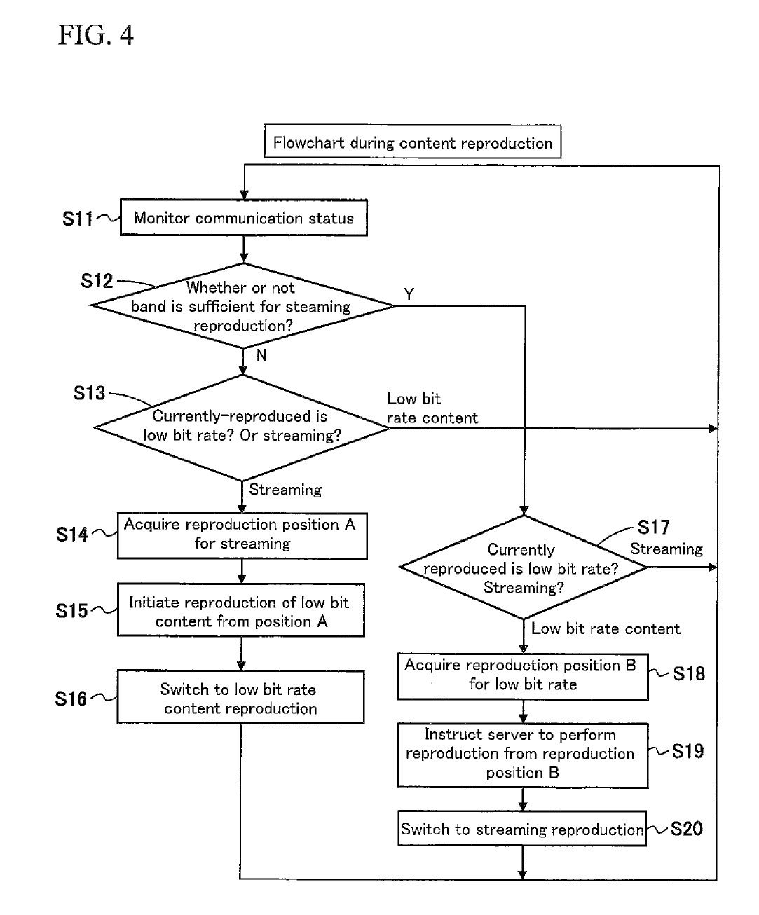

FIG. 4 is a flowchart diagram illustrating a processing during content reproduction. As shown in FIG. 4, the communication status is monitored in a step S11, and then it is judged in a step S12 whether or not there is a sufficient remaining band for streaming reproduction. If there is a sufficient band (Y), operation proceeds to a step S17, while operation proceeds to a step S13 if a remaining band is not sufficient (No). In the step S13, it is judged whether a content which is currently reproduced is a low bit rate content or streaming. If it is a low bit rate content, operation goes back to the step S11. If it is streaming reproduction, operation proceeds to a step S14, and a reproduction position A for streaming (for notifying the CPU of a detection result by the communication status detection part 27) is obtained in the case where the communication status is retrieved. Next, in a step S15, reproduction of a low bit rate content is initiated from the position A. In a step S16, a switchover to a low bit rate content reproduction is carried out, and then operation goes back to the step S11. If Y in the step S12, operation proceeds to a step S17. In the step S17, it is judged whether a content which is currently reproduced is a low bit rate content or a streaming content. If it is a streaming content, operation goes back to the step S11. If it is a low bit rate content, operation proceeds to a step S18, and a reproduction position B for low bit rate is obtained. In a step S19, reproduction from the reproduction position B is requested to the server 1 (FIG. 1). In a step S20, a switchover to streaming reproduction is carried out, and operation goes back to the step S11.

FIG. 5 is a flowchart diagram illustrating a processing flow at a time of completing. As shown in FIG. 5, in a step S21, content reproduction (streaming, low bit rate) is completed or a termination instruction from a user is received. Subsequently, a termination processing of reproduction is carried out in a step S22, and then, in a step S23, it is judged whether or not the low bit rate content needs to be deleted because it is a copyrighted content. If N, the processing is terminated in a step S25. If Y, the low bit rate content is deleted in a step S24, and then the processing is terminated (step S25).

As described above, in a content reproducing technique according to the present embodiment, a portable content reproducing device which obtains a content from a communication part and enables streaming reproduction includes a temporary recording device that is capable of accumulating a content at least temporarily and records a low bit rate stream file in the temporary recording device simultaneously with streaming reproduction.

Here, the following relationship, a rate of streaming reproduction<a rate allowing communication, is established. Therefore, by using a surplus band, which is not used for streaming reproduction, within the whole band, a low bit rate stream file having the same content is downloaded to the temporary recording device. A reporting part configured to notify a user, when the download of a low bit rate file is completed, of the completion.

In the case where multiple contents having different bit rates are prepared as a low bit rate content provided by the server 1, information regarding the communication status and a time for how long staying at the location will be and a free space of the hard disk (HDD) 17 are presented to a user. The user can select an appropriate low bit rate content according to bit rate from the provided low bit rate contents.

When the communication status is deteriorated or interrupted, there is a possibility that underflow occurs in streaming reproduction at a certain reproducing point. In such a case, a switchover can be performed to reproduce, from the reproducing point, a content file recorded at a low bit rate.

The reporting part can notify a user that the communication status has been retrieved during reproduction. In addition, an input part is provided with which a user, who has determined whether or not to switch streaming reproduction, performs input operation in the case where the user actually performs the switchover.

When the communication status is retrieved, it is possible to switch, either in response to the input of a user or automatically, to high bit rate streaming reproduction continued from a reproducing point in the reproduction at a low bit rate. A high-quality content can be provided for viewing.

Here, after the completion termination of reproduction, in the case where copyright protection of the content is required, it is possible to automatically perform deletion of the low bit rate content stored in the hard disk (HDD).

As shown as an example in FIG. 6(A), suppose that a maximum capacity band of a system according to the present embodiment is 12 Mbps and streaming reproduction (1a) is carried out at a time t1 at 10 Mbps. In such a case, a remaining band is 2 Mbps. FIG. 6(B) illustrates three contents held in the server 1, and indicates that the contents having a bit rate of 10 M, 2 M, and 500 kbps, are available. The communication status is shown as a curbed line in the drawing.

Here, the same content is separately downloaded to the HDD at a band of 2 Mbps or smaller (region X: using a content 1b). At a time tx, download of the low bit rate content (1b) is completed. When the streaming reproduction (1a) at 10 Mbps has proceeded up to 70% (at a time t2), if the communication status is deteriorated, for example, the streaming reproduction (1a) becomes difficult. Accordingly, reproduction is suspended, for example, at a time t2, and then, from the time t2, a low bit rate content which has been downloaded separately by the time tx is reproduced as shown by a thick line. In this example, the communication is impossible at a time ty that comes after the time t2. However, even in such a case, reproduction can be continued, as shown by the thick line, by using the low bit content which has been downloaded separately. After this, the content 1b may remain to be reproduced to its end. However, if the communication status detection part 27 detects that the communication status is retrieved at a time t3 coming after the time t2 at which the streaming reproduction (1a) is interrupted (suppose that 90% of the content has been already reproduced), streaming reproduction of the content can be carried out with a band of 10 Mbps. Then, when viewing of the entire content is completed at a time t4 (100%), streaming reproduction is ended.

As described above, according to the content reproducing technique according to the above embodiment, there is an advantage that, even in the case where the communication status becomes bad, a content can be reproduced continuously by using a low bit rate content that has been recorded.

Here, a publicly-known technique can be used to determine from which position of a content the reproduction is started at the switchover of the content. For example, in one employable method, a whole content is assumed to be 100%, and, when the switchover of contents is carried out, the content to be reproduced after the switchover is reproduced from the position determined according to how many percentages (here, suppose X%) of the content has already been reproduced, i.e., from the position after X% from the beginning of the content.

Next, another example of the content reproducing technique according to the present embodiment will be described by referring to drawings. The content reproducing technique according to the present embodiment is, as shown in FIG. 6(B), characterized in that multiple contents which are each encoded at a different bit rate are downloaded. Suppose, for example, in FIG. 6(A), the entire band is 24 Mbps. In this case, when stream reproduction is performed at 10 Mbps, all of the content 1a of 10 Mbps, the content 1b of 2 Mbps, and the content 1c of 500 kbps, which are show in FIG. 6(B), can be downloaded. Thereafter, when the communication status is deteriorated, according to a user designation, it can be determined which one of the contents 1a to 1c is to be reproduced. For example, according to a remaining battery level in the content reproducing device, it can be determined which one of the contents 1a to 1c is to be reproduced. Furthermore, on a temporal axis, reproduction can be performed while selecting contents having different bit rates.

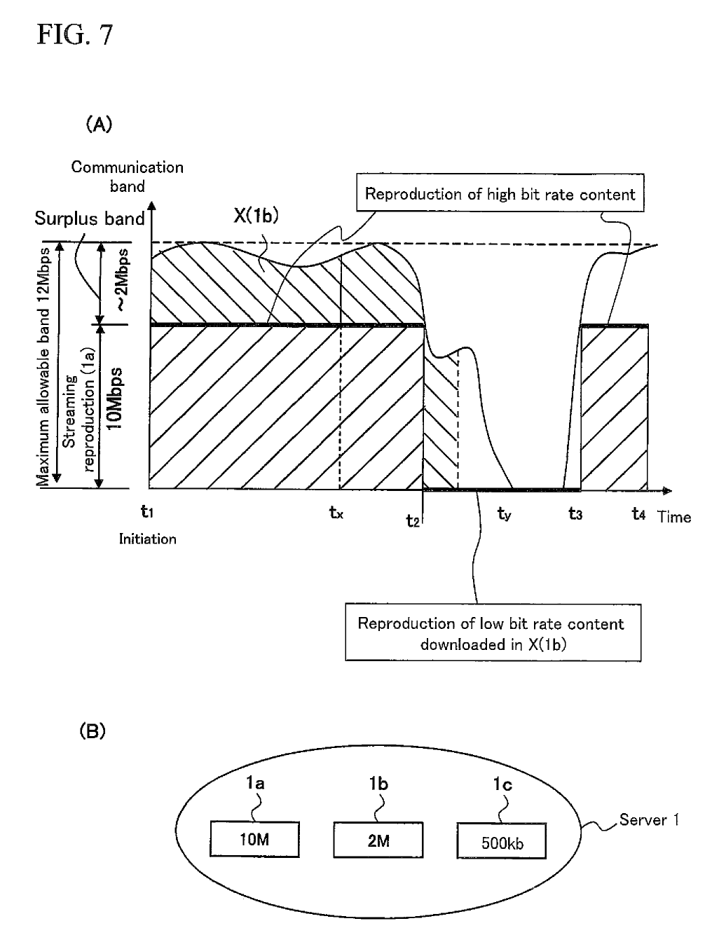

Next, a first example of the present embodiment will be described by referring to drawings. FIG. 7(A) is a timing chart diagram regarding content reproduction according to the present example, and FIG. 7(B) is a diagram illustrating an example of a content group existing in the server 1 regarding the first example.

As for the example illustrated in FIG. 7, the diagram illustrates an example in which the streaming reproduction (1a) is initiated at a time t1 and download of a low bit rate content is continuously carried out even at a time t2 at which the streaming reproduction (1a) is interrupted because the communication band is narrowed. In this case, a download processing of the low bit rate content is continuously carried out just before a timing ty at which the communication is interrupted. At t4, content reproduction is finished.

Here, from t1 to t2 and from t3 to t4, streaming reproduction at a high bit rate is carried out.

With such a configuration, as shown in FIG. 7(A), even in the case where an available communication band is only one which does not allow streaming reproduction at a high bit rate, the period of the reproduction can be made longer by performing a download processing of a low bit rate content. Therefore, the communication band can be efficiently used.

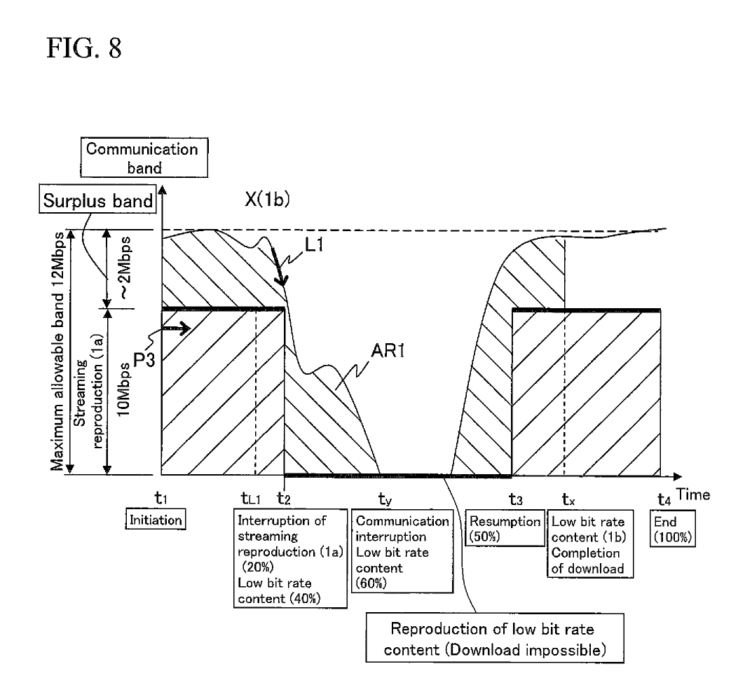

Next, a content reproducing technique according to a second example of the present embodiment will be described by referring to drawings. As shown in FIG. 8, the communication status is monitored from a timing t1 at which the streaming reproduction (1a) is initiated. Then, if, at a time point, for example, t_{L1}, which comes before a timing t2 at which streaming reproduction is interrupted, a decrease in the communication band is detected as shown by a symbol L1, it can be predicted that streaming reproduction will be impossible at a certain timing coming thereafter. Therefore, before the timing t2 at which streaming reproduction is interrupted, reproduction of a download content can be prepared. Then, at the interruption timing t2, reproduction at a low bit rate can be immediately carried out. In the meantime, as for a region AR1 coming after t2, streaming is resumed at t3, a low bit rate content (1b) is downloaded at tx, and reproduction is finished at t4. In this case, regarding the period from t2 to t3, although streaming reproduction at a high bit rate cannot be performed, it can be used for download of a low bit rate content. Accordingly, the communication band can be used efficiently. Furthermore, judgment regarding a switchover between streaming reproduction and reproduction of a low bit rate content can be performed earlier, a processing rate and processing efficiency can be further improved.

In the case where the reception status of communication starts to be deteriorated as described above, if a low bit rate content has not been acquired up to a position allowing reproduction thereof, streaming currently being reproduced is continuously carried on while performing congestion control or the like. If a low bit rate content has been acquired up to a position allowing reproduction thereof, a content to be reproduced is switched to a low bit rate content. Then, if ally part of the low bit rate content has not been acquired, it is possible to perform control so as to give priority to download of the remaining low bit content by using the communication band.

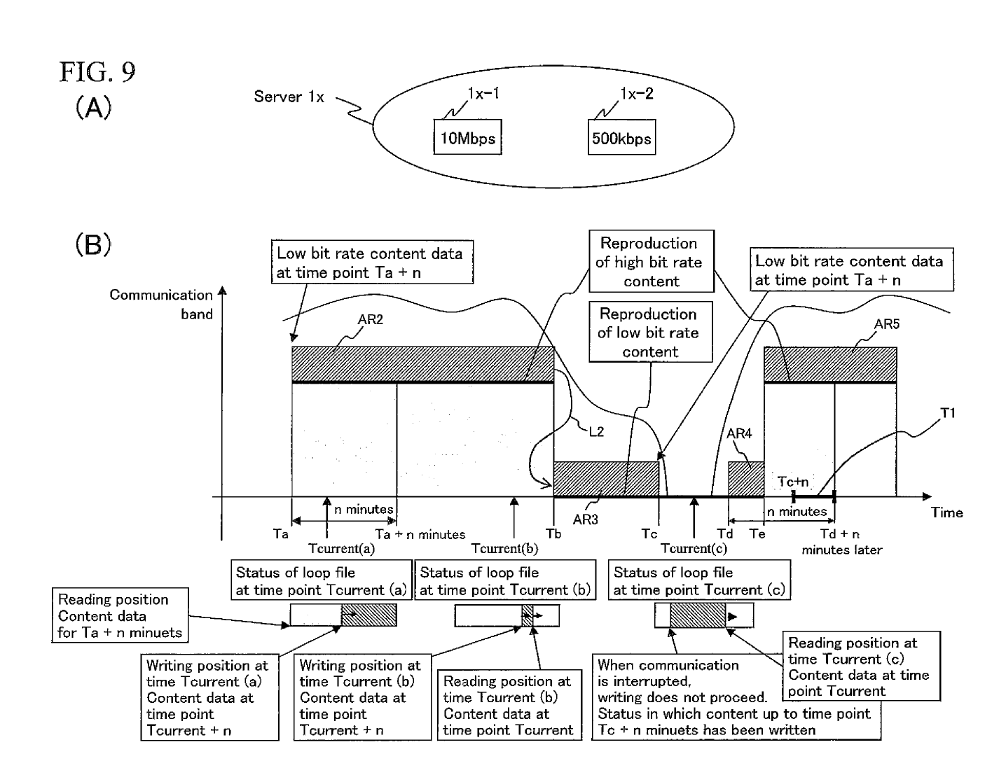

FIG. 9 is a Liming chart diagram regarding content reproduction according to a third example of the present embodiment. FIG. 9(A) is a diagram illustrating an example of a content which is held in a server 1x and can be provided to the content reproducing device. As shown in the drawing, in a server apparatus 1x, there are a content 1x-1 of a high bit rate (10 M) and a content 1x-2 of a low bit rate (500 kb) which can send a content of, for example, n (minutes) after the content 1x-1 to the content reproducing device. The server apparatus 1x sends both contents simultaneously to the content reproducing device. A view illustrating this operation is FIG. 9(B). Real-time streaming viewing is initiated at Ta, and, at the same time, acquisition of a content, which is being sent at a low bit rate, for a time point Ta+n minutes is initiated. Here, in a region AR2, a low bit rate content for the reproduction after n minutes is always streamed. Accordingly, Ta+n minutes thereafter, a switchover to a low bit rate content is possible. A content at the AR2 part can be subjected to download of a low bit rate content in a AR3 region which is initiated at Tb as shown by a symbol L2. Here, since the communication status is deteriorated at Tb, both reproduction of a low bit rate content and all possible download processing (AR3) of a low bit rate content can be performed. Note that, even if the communication is completely interrupted at Tc, reproduction of a low bit rate content is possible for n minutes from this point. If the communication starts is retrieved a little before a time Td, acquisition by download of a low bit rate content can also be resumed (a region indicated by a symbol AR4). Furthermore, when the communication status is retrieved, a switchover to real-time streaming at a time Te is possible. In addition, as shown by a symbol AR5, acquisition of a low bit rate content is possible. Here, at the time Tc, a low bit content up to Tc+n minutes has been obtained in AR3. Therefore, if Tc+n<Te, viewing of the whole content without interruption is possible. Since acquisition of a low bit rate content from the time Td to a time point Td+n minutes has been initiated, it can be judged that, Td+n minutes thereafter, a switchover to a low bit rate content is possible.

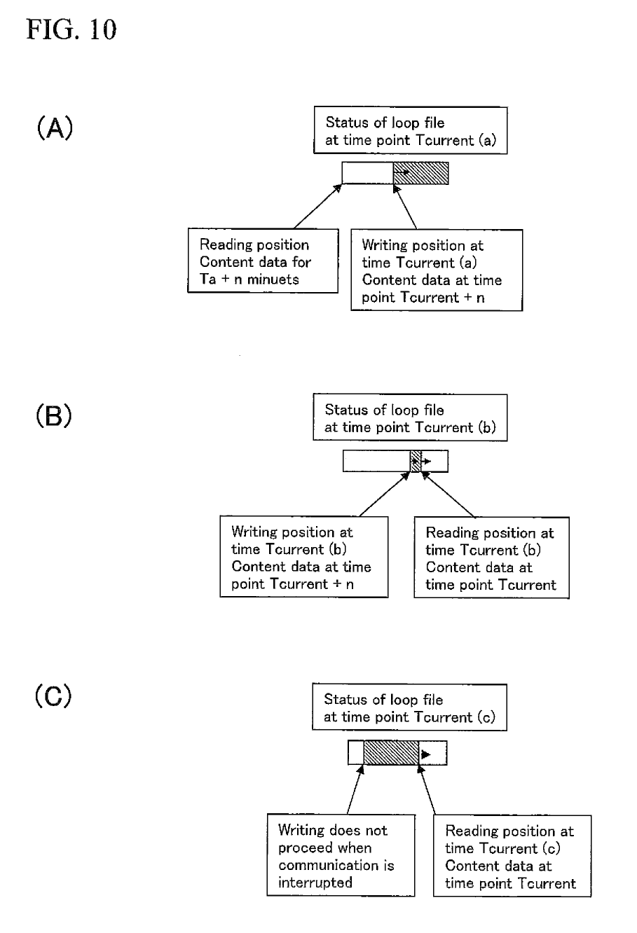

FIG. 10 is a diagram illustrating a configuration example of a loop file stream according to the third example regarding a content after n minutes. Here, the loop files illustrated in FIG. 10(A) to FIG. 10(C) are also arranged on a time axis in FIG. 9. Tcurrents (a to c) in FIG. 10 each represent a time point indicated by an arrow in FIG. 9, and Tcurrent (a) represents the time at a certain time point between Ta and Ta+n minutes, Tcurrent (b) represents the time at a certain time point between Ta+n and Tc, and Tcurrent (c) represents the time at a certain time point between Tc and Td.

As shown in FIG. 10, a concept of a loop stream file having a size of a bit rate×time will be described. When writing is reaching the end of a loop file 31a, operation goes back again to a starting position P3 and writing is initiated therefrom. Continuous writing with a constant file size is possible. “Reading position” and “writing position” in FIG. 10 respectively indicate their positions at Tcurrent, and the description of “content data at a time point of . . . ” means that the content of the data is a viewable content at the time point. Therefore, in the case where the current time is Tcurrent, at the time of Tcurrent, a content at a time point “Tcurrent+n minutes” has been acquired as a low bit rate content.

FIG. 10(A) is a diagram illustrating a progression of writing of a low bit rate stream started from the starting position of the file (described in association with FIG. 9). To be more specific, recording of content data for a time point “Ta+n minutes” is initiated from a time Ta, and writing of content data for a time point “Tcurrent (a)+n minutes” is in progress at Tcurrent (a). Content data is further recorded continuously, and then a time “Ta+n minutes” has come. In the drawing, the halfway progression thereof is illustrated. In the case where a current time during this period is set to Tcurrent (a), firstly, recording of a content for the time point “Ta+n minutes” is initiated from the time Tcurrent (a) (=Ta), and a switchover to a low bit rate content is not possible until Tcurrent (a) reaches Ta+n. A writing position at the time Tcurrent (a) corresponds to the content data at a time point “Tcurrent+n minutes.” Here, FIG. 10(B) illustrates a status of a loop stream file from Ta+n minutes to Tc in FIG. 9, and, during this period, a switchover to a low bit content is possible. In other words, at a writing position at a time Tcurrent (b) in FIG. 9(B), content data at a time point “Tcurrent (b)+n minutes” has been recorded. A reading position at the time Tcurrent (b) is content data for the time point Tcurrent (b).

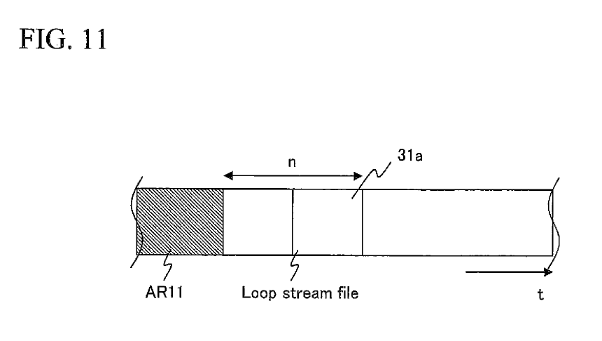

Next, as shown in FIG. 10(C), in a loop stream file 31c including a period of interrupted communication, after a switchover to a low bit rate content, writing does not proceed when the communication is being interrupted. After the communication is recovered, a wiring position proceeds. However, in such a case, some period of time is missing. Accordingly, n minutes after the position, the status in which a switchover to a low bit rate content is possible is achieved. A reading position at a time Tcurrent (c) is content data at the time point Tcurrent (c). For ease in understanding, the loop stream file in FIG. 10 is also described in FIG. 9 in association therewith. In the meantime, as shown in FIG. 11, regarding a status in which a part corresponding to the loop stream file 31 (for n minutes) proceeds on the time axis, there is also a method in which a buffer memory is used to sequentially erase a region AR11 before the loop stream file 31.

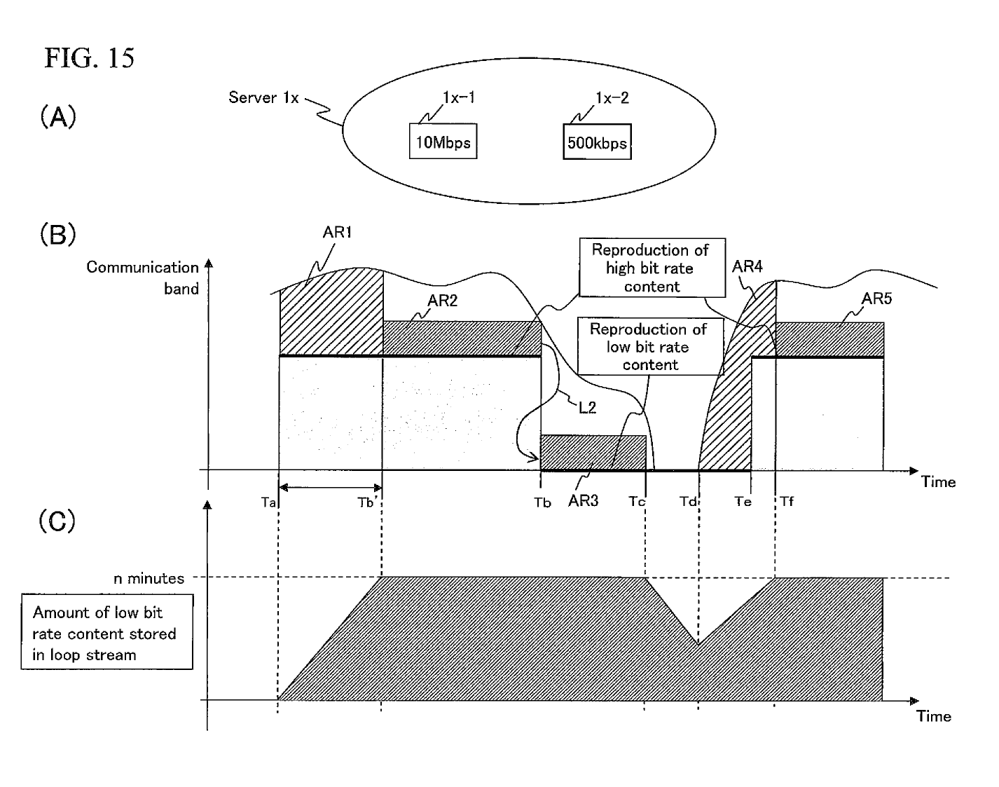

FIG. 15 is a diagram corresponding to FIG. 9. As similar to FIG. 9, FIG. 15 shows a case where a high bit rate content is continuously streamed like a broadcast, and where a low bit rate content is downloadable not as a streaming but as a content.

FIG. 15(B) is a timing chart diagram regarding content reproduction according to a fourth example of the present embodiment. A real-time streaming viewing is initiated at Ta, and, at the same time, download at a low bit rate by using a surplus band indicated by AR1 is continuously carried out until a portion having the size of a loop stream file (n minutes) has been recorded. In other words, the region of AR1 is used for download of an n-minute loop stream. At a time Tb′, after the n-minute content has been accumulated in the loop stream file, a switchover is performed so as to download a low bit rate content corresponding to a portion of a time proceeded, and recording is continued by using the communication region of AR2. At a time Tb, if the communication status is so deteriorated that reproduction of a high bit rate streaming content cannot be continued, reproduction is switched to that at a low bit rate. During the period from Tb to Tc, download of the low bit rate content can be also carried out as much as possible. Even if the communication is completely interrupted at Tc, reproduction of the low bit rate content is possible for n minutes. If the communication starts to be recovered just before a time Td, acquisition of the low bit rate content by download can also be resumed. At this time, the amount of content recorded in the loop stream file is reduced by a portion of time of the communication interruption. Therefore, as similarly to AR1, until an n-minute low bit rate content has been accumulated in the loop stream file, download of the low bit rate content is continued (a region indicated by a symbol AR4).

When the communication status is further retrieved at Te, a switchover to the high bit rate streaming content can be carried out. During the time from Te to Tf, by using a surplus band, download of the low bit rate content can be continued. At a time Tf, when an n-minute low bit rate content has been accumulated in the loop stream file, a switchover is performed so as to download the low bit rate content by a portion of a time proceeded.

FIG. 15(c) is a time chart illustrating the amount of the low bit rate content accumulated in the loop stream file. During the period from Ta to Tb′, the low bit rate content is downloaded by using the entire surplus band until the low bit rate content for n minutes is accumulated in the loop stream file. Accordingly, the writing rate is faster than the reading rate, and the amount of the content accumulated in the loop stream file keeps increasing. During the period from Tb′ to Tc, the writing rate and the reading rate of the loop stream file are kept the same. Accordingly, the amount of the content accumulated in the loop stream file is hardly changed. When download of the low bit rate content becomes impossible at Tc, writing is terminated while only reading proceeds. Accordingly, the amount of the low bit rate content accumulated in the loop stream file starts to be decreased. When the communication is recovered at Td, the low bit rate content may be continuously downloaded by using the communication region, for example, the entire communication region since the low bit rate content for n minutes has not been accumulated. Then, even after the communication is further recovered and a switchover to high bit rate streaming is performed at Te, the low bit rate content may be continuously downloaded by using a surplus band until the low bit rate content for n minutes is accumulated. When the low bit rate for n minutes is already accumulated in the loop stream file at Tf, the download rate is set to be equal to the reading rate. Therefore, the amount of the content accumulated in the loop stream file does not change any more.

Here, in FIG. 15(C), from Ta to Tb′ and from Td to Te, for simplification of the drawing, the status in which the amount of the content increases and decreases is shown in a linear manner. However, in actuality, the amount fluctuates by the communication status and the like, thereby drawing a curve. Here, it is illustrated as a schematic drawing.

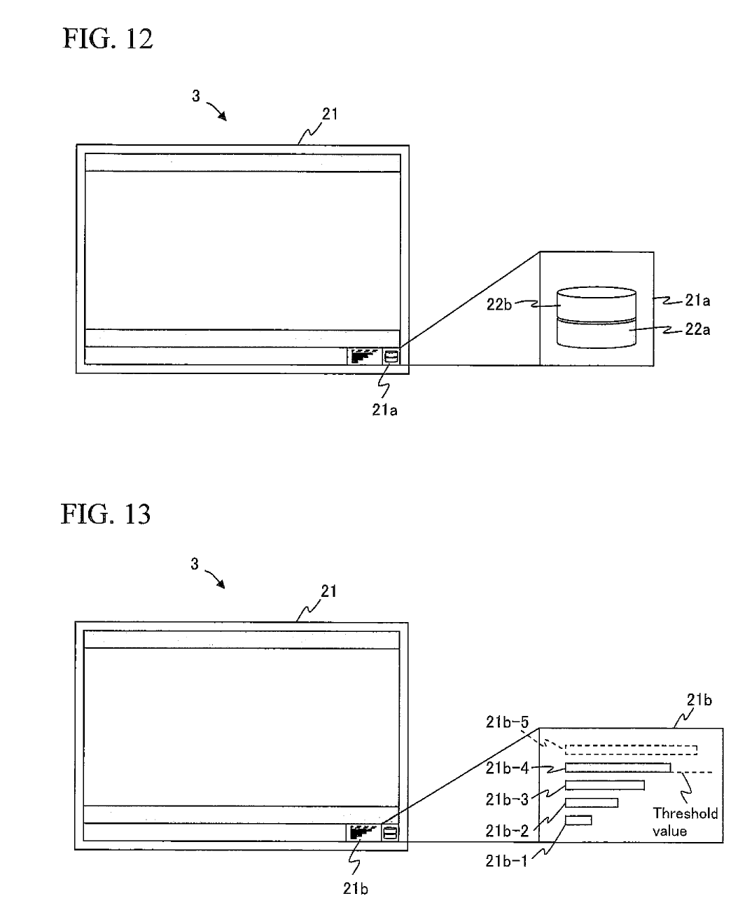

Next, a display example in the content reproducing device will be described. FIG. 12 is a view illustrating a first display example of the content reproducing device of according to the present embodiment. A display screen 21 of the content reproducing device illustrated in FIG. 12 may be provided, for example, at the right bottom corner thereof, with a progress status display region 21a of download processing of a low bit rate content. An enlarged view of the progress status display region 21a illustrated on the right hand side provides the display of a memory unit having an HDD shape in which a part 22a indicating an already-downloaded portion and a part 22b indicating a still-empty portion are displayed in a visually distinguishable manner. Here, they are distinguished by color. By looking at this display, it is possible to know the progress status regarding the download of the low bit rate content. Furthermore, the progress status display region 21a may be configured to, for example, change color when reproduction of a low bit content becomes possible, and to change color to indicate that a low bit rate content is being reproduced.

FIG. 13 is a view illustrating a second display example of the content reproducing device according to the present embodiment. As shown in FIG. 13, for example, it is also possible to display a communication band status display region 21b indicating current communication band information near the progress status display region 21a. The communication band status display region 21b is composed of a bar-chart display having bars 21d-1 to 21b-5 with different heights, and is configured to display whether or not streaming reproduction is possible with a certain threshold value as a reference. If it is set that streaming reproduction is possible when up to 21b-3 are colored, a user can distinguish at a glance whether or not streaming reproduction is possible by looking at the display. Furthermore, it is also possible to allow a user to understand this more easily by changing color during streaming reproduction.

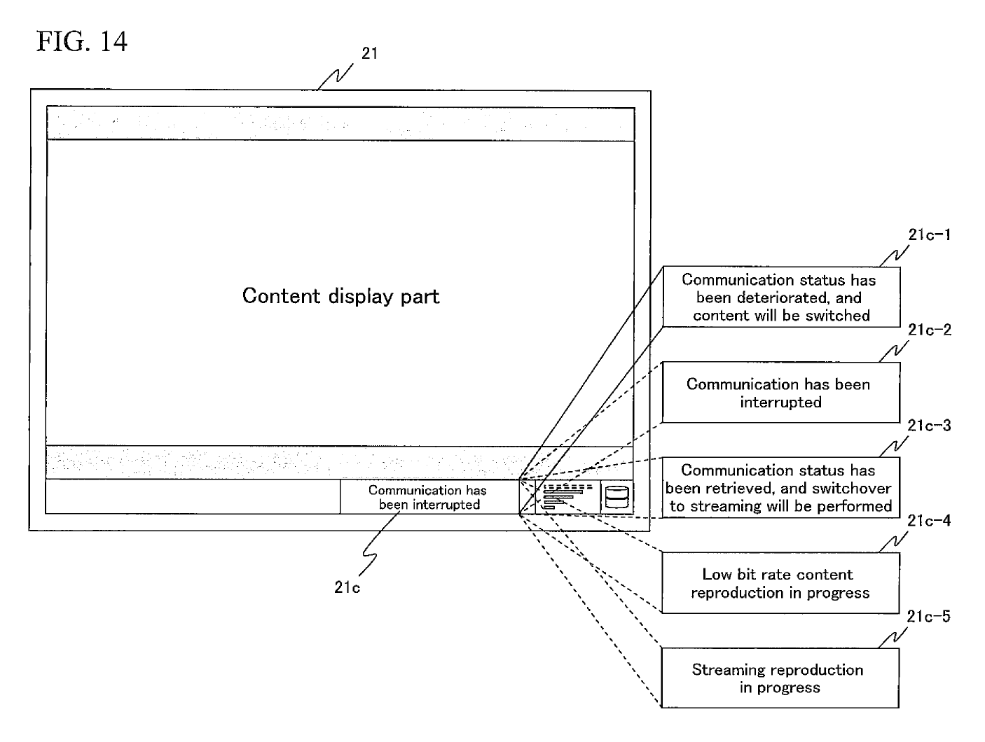

Next, by referring to FIG. 14, a third display example of the content reproducing device according to the present embodiment will be described. As shown in FIG. 14, in the content display part 21, an announce display part 21c is provided, and is configured to announce various information. For example, when the communication status is deteriorated, a display 21c-1 announces “a content will be switched,” a display 21c-2 announces “the communication has been interrupted,” a display 21c-3 announces “the communication status has been retrieved, and a switchover to streaming will be performed,” 21c-4 announces “low bit rate content reproduction in progress,” and 21c-5 announces “streaming reproduction in progress.” There is an advantage that a user can understand the current status correctly by receiving such announces.

As describe above, there is an advantage that using the content reproducing technique according to the present embodiment further enhances flexibility in content reproduction because contents having different bit rates are downloaded to a HDD in a content reproducing device.

### INDUSTRIAL APPLICABILITY

The present invention can be used for a content reproducing device, for example, a portable terminal and the like, that allows streaming reproduction.

1-26. (canceled)

27. A content reproducing device capable of performing content reproduction, characterized by comprising:
a content acquiring part for receiving a content;
a content storing part for storing the content acquired;
a reception status detecting part for detecting a reception status of the content; and
a controlling part for performing control such that, while the content acquisition part is receiving a stream content, a content that is the same content as the stream content and has a bit rate smaller than that of the stream content is downloaded by using a surplus band and is stored in the content storing part, depending on the reception status of the content detected by the reception status detecting part and, one of the plurality of contents having the smaller bit rates is selected for download, according to a bandwidth of the surplus hand.

28. The content reproducing device according to claim 27, characterized in that the controlling part performs control such that, in response to the reception status of the content detected by the reception status detecting part, the stream content is directly received and reproduced in the case where the reception status is good enough to allow reception of the stream content, while the content being the same as the stream content and stored in the content storing part is reproduced in the case where the reception status of content is not good enough to allow reception of the stream content.

29. The content reproducing device according to claims 27, characterized in that a timing of a switchover between the stream content and the content having the smaller bit rate is adjusted on the basis of any of a percentage of an already-reproduced portion with respect to the content and a percentage of a yet-to-be-reproduced portion with respect to the content.

30. The content reproducing device according to claim 27, further characterized in that, when download of a low bit rate content is completed, a completion notification is provided.

31. The content reproducing device according to claim 27, characterized in that the controlling part performs control such that a group of contents having variety of bit rates smaller than that of the stream content is downloaded by using a surplus band and stored in the content storing part.

32. A content reproducing system, comprising:
a content server for providing a content; and
a content reproducing device capable of performing content reproduction, the content reproducing device including:
a content acquiring part for receiving a content from the content server;
a content storing part for storing the content acquired;
a reception status detecting part for detecting a reception status of the content; and
a controlling part for performing control such that, while the content acquisition part is receiving a stream content, a content that is the same content as the stream content and has a bit rate smaller than that of the stream content is downloaded by using a surplus band and is stored in the content storing part, depending on the reception status of the content detected by the reception status detecting part and, one of the plurality of contents having the smaller bit rates is selected for download, according to a bandwidth of the surplus band.

33. A content reproducing method, characterized by comprising the steps of:
judging whether or not there is a surplus band in a communication band, and, in the case where there is a surplus band, inquiring of an external content server whether or not there is a low bit rate content that is the same content as the stream content;
in the case where there is the low bit rate content, downloading the low bit rate content by using the surplus band; and,
in response to a reception status of the content, directly receiving and reproducing the stream content in the case where the reception status of content is good enough to allow reception of the stream content, while reproducing the low bit rate content stored in the content storing part in the case where the reception status of content is not good enough to allow reception of the stream content,
wherein one of the plurality of contents having the smaller bit rates is selected for download, according to a bandwidth of the surplus band.

34. The content reproducing method according to claim 33, characterized by comprising a step of performing a switchover between reproduction of the stream content and reproduction of the low bit rate content in accordance with the reception status.

35. A program for causing a computer to execute the steps according to claim 33 or 34.

36. The content reproducing device according to claim 27, characterized in that, in the case where a communication band sufficient to allow viewing of the stream content is not secured and where download of the content having the smaller bit rate has not been completed, the controlling part continues to download the content having the smaller bit rate if possible.

37. The content reproducing device according to claim 27, characterized in that, in the case where a communication reception status starts to be deteriorated, and if the content having the smaller bit rate has not been acquired up to a position allowing reproduction, the controlling part continues a processing on a streaming currently being reproduced.

38. The content reproducing device according to claim 27, characterized in that, in the case where a communication reception status starts to be deteriorated, and if the content having the smaller bit rate has been acquired up to a position allowing reproduction, the controlling part performs a processing to switch a content to be reproduced to the content having a smaller bit rate.

39. The content reproducing device according to claim 27, characterized in that, in the case where a communication reception status starts to be deteriorated, and if there remains a yet-to-be-acquired part of the content having the smaller bit rate, the controlling part performs a processing to give a priority to download of the remaining part of the content having a smaller bit rate in using a communication band.

40. The content reproducing device according to claim 27, characterized in that, in the case where real-time streaming is carried out, a portion of the low-bit rate content after n minutes behind the real-time streaming is simultaneously subjected to streaming.

41. The content reproducing device according to claim 27, characterized in that the controlling part performs a processing in which:
a low bit rate content which is simultaneously subjected to streaming is recorded in a recording media;
in the case where the communication status becomes deteriorated enough not to allow a high bit rate streaming to be performed, a switchover to a low bit rate content recorded in the recording media is performed and reproduction continues to reproduce the low bit rate content for a time for which the low bit rate content has been recorded.

42. The content reproducing device according to claim 27, characterized in that
the controlling part records in a recording media a low bit rate content which is simultaneously subjected to streaming, and,
even in the case where the communication status becomes deteriorated enough not to allow a high bit rate streaming to be performed, the controlling part acquires a low bit rate content continuously.

43. The content reproducing device according to claim 27, characterized by comprising
a content status notifying part that provides a notification of at least any one of a communication status and a content reproduction status, characterized in that
a switchover of a content is performed according to the communication status, and
a notification of the communication status is provided.
